(19) United States
(12) Patent Application Publication
(10) Pub. No.: US 2025/0132075 A1
(43) Pub. Date: Apr. 24, 2025

(54) SHUNT RESISTOR

(71) Applicant: KOA Corporation, Nagano (JP)

(72) Inventors: Yoichi Sakai, Nagano (JP); Keishi Nakamura, Nagano (JP); Toshifumi Mizokami, Nagano (JP)

(21) Appl. No.: 18/682,589

(22) PCT Filed: Aug. 3, 2022
(86) PCT No.: PCT/JP2022/029823

§ 371 Date: Feb. 9, 2024

(30) Foreign Application Priority Data
Aug. 27, 2021 (JP) 2021-139180

(51) Int. Cl. H01C 13/00; H01C 1/14

(52) U.S. Cl. CPC H01C 13/00; H01C 1/14

(57) ABSTRACT

The shunt resistor includes: the resistance body; and the electrode joined to the resistance body and made of aluminum as a main component. In addition, the shunt resistor includes the plated portion configured to cover at least the joined portions between the resistance body and the electrode the plated portion being configured of a plating having higher specific resistance than the resistance body.

### CROSS-REFERENCE TO RELATED APPLICATIONS

This application is the U.S. national stage of PCT/JP2022/029823 filed on Aug. 3, 2022, which claims priority of Japanese Patent Application No. JP 2021139180 filed on Aug. 27, 2021, the contents of which are incorporated herein.

### TECHNICAL FIELD

The present disclosure relates to a shunt resistor.

### BACKGROUND

JP2003-031401A discloses a resistor that includes a resistance body and a first terminal and a second terminal respectively provided on both end portions of the resistance body. The first terminal and the second terminal of the resistor are each formed of a metal such as aluminum, etc.

In addition, JP2019-161225A discloses a shunt resistor capable of suppressing galvanic corrosion due to contact between dissimilar metals by coating a contact portion between dissimilar metals of an aluminum alloy and a copper alloy. It is stated that a plating process to coat a thin metal film can be employed for this coating.

### SUMMARY

However, there is a possibility in that the resistance characteristics may be affected if the metal plating is bridged between the electrodes and the resistance body.

An object of the present disclosure is to achieve suppression of influence imparted to resistance characteristics.

According to an aspect of the present disclosure, a shunt resistor includes: a resistance body; an electrode joined to the resistance body and made of aluminum as a main component; and a plated portion configured to cover at least a joined portion between the resistance body and the electrode, the plated portion being configured of a plating having higher specific resistance than the resistance body.

According to the present aspect, the joined portion between the resistance body and the electrode is covered by the plated portion having higher specific resistance than the resistance body. Therefore, compared with a case in which the electrode and the resistance body are bridged by the plating having lower specific resistance than the resistance body, the current flowing through the plated portion is suppressed, and therefore, it is possible to suppress the influence of the plated portion imparted to the resistance characteristics of the shunt resistor.

### BRIEF DESCRIPTION OF DRAWINGS

FIG. 1 is a perspective view showing a shunt resistor according to a first embodiment.

FIG. 2 is an explanatory diagram used for explaining a relationship between a range and an effect of a plated portion in the shunt resistor according to the first embodiment.

FIG. 3 is a graph showing a relationship between an added amount of phosphorus and a specific resistance, and a relationship between the added amount of phosphorus and a temperature coefficient of resistance in a plating material used in the first embodiment.

### DETAILED DESCRIPTION OF PREFERRED EMBODIMENTS

In recent years, emission regulations have been tightened in many countries in response to environmental concerns, and the development of electric vehicles (EV) is progressing.

In the electric vehicles, an weight reduction is required in order to extend an EV range. Therefore, members forming parts of the electric vehicles have been replaced with those made of aluminum. The parts used in the electric vehicles include electrodes and electric wires of a battery, and the materials for the electrodes and the materials for the electric wires of the battery are considered to be replaced with aluminum.

Thus, also for a shunt resistor that is a current sensing resistor used for the electric vehicle, the inventors have considered to achieve reduction in the weight of the shunt resistor by forming the shunt resistor using a material containing aluminum as a main component.

If dissimilar metals are connected, a local cell is formed at the contact due to the difference in standard electrode potentials, and there is a possibility in that a galvanic corrosion is caused due to the presence of moisture, etc. This galvanic corrosion appears significantly when the metal is aluminum.

In a case in which the electrodes are made of the material containing aluminum as the main component, if the resistance body is made of a resistance body material with a large potential difference from the standard electrode potential of aluminum, the galvanic corrosion may be caused due to the contact between dissimilar metals. As the resistance body material that may cause the galvanic corrosion, for example, copper, chromium, iron, and so forth are assumed.

The inventors have devised the shunt resistor capable of suppressing the occurrence of the galvanic corrosion while achieving the reduction in weight.

In the following, a first embodiment of the present disclosure will be described. The shunt resistor shown in this embodiment is not limited to the shunt resistor used in the electric vehicle, and it can be used as a general shunt resistor.

### Shunt Resistor

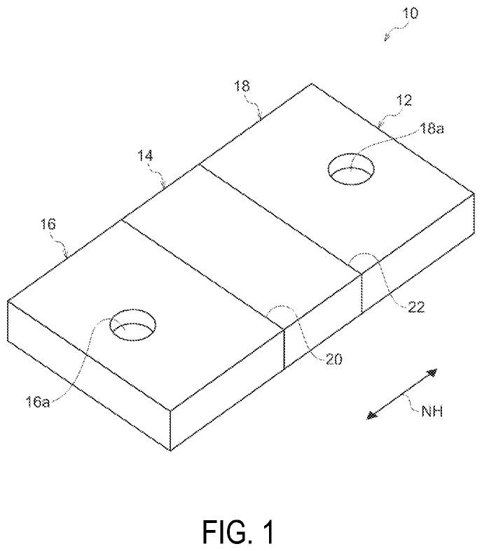

FIG. 1 is a perspective view showing a shunt resistor 10 according to the first embodiment. For the sake of simplification of the description, FIG. 1 shows the shunt resistor 10 from which a plated portion 30, which will be described below, is excluded.

As shown in FIG. 1, a resistor main body 12 of the shunt resistor 10 is provided with a resistance body 14 and electrodes 16 and 18 that are respectively joined to the resistance body 14 and arranged side by side with the resistance body 14. The electrodes include the first electrode 16 that is joined to a first end of the resistance body 14 and the second electrode 18 that is joined to a second end of the resistance body 14. A first hole 16a is formed in the first electrode 16, and a second hole 18a is formed in the second electrode 18.

A first joined portion 20 is formed at a joined portion between the resistance body 14 and the first electrode 16. A second joined portion 22 is formed at the joined portion between the resistance body 14 and the second electrode 18.

A method for joining the resistance body 14 with each of the electrodes 16 and 18 includes a fusion welding by which materials to be joined are mutually melted and joined, a pressure welding by which the materials to be welded are joined by diffusion of metal atoms, and a soldering by which the materials to be welded are joined via a conductive material such as a brazing filler, etc.

In this embodiment, the soldering by which the joining is achieved with the conductive material such as the brazing filler, etc. is not used, and the resistance body 14 and each of the electrodes 16 and 18 are joined by the fusion welding or the pressure welding. An example of the fusion welding includes a laser welding or an electron-beam welding.

As a result, in this embodiment, the conductive material such as the brazing filler, etc. is not interposed between the resistance body 14 and each of the electrodes 16 and 18, and the resistance body 14 and each of the electrodes 16 and 18 are joined to each other, and therefore, the improvement of the the resistance characteristics of the shunt resistor 10 is achieved.

The resistance body 14 has a rectangular plate shape. Each of the electrodes 16 and 18 also has a rectangular plate shape. The widths of the resistance body 14 and each of the electrodes 16 and 18 are set so as to have substantially the same dimension. With such a configuration, the shunt resistor 10, in which the resistance body 14 and each of the electrodes 16 and 18 are joined, is formed to have a rectangular plate shape elongated in the direction NH in which each of the electrodes 16 and 18 and the resistance body 14 are aligned.

### Conductive Material

Each of the electrodes 16 and 18 is made of the conductive material containing aluminum (Al) as the main component. The phrase “containing aluminum as the main component” means that the content of aluminum is equal to or higher than 50 mass % relative to the total mass of each of the electrodes 16 and 18. The content of aluminum is preferably equal to or higher than 80 mass %, and more preferably equal to or higher than 90 mass %.

The conductive material containing aluminum as the main component includes, for example, pure aluminum having a purity of 99% or more, or an aluminum alloy.

### (Resistance Body Material)

The resistance body material forming the resistance body 14 includes, for example, a copper-manganese alloy, a copper-nickel alloy (for example, one type of copper-nickel, nickel silver, constantan, and so forth), a nichrome alloy (one type of nichrome, Evanome, NiCrMo steel, and so forth), or an iron-chromium alloy.

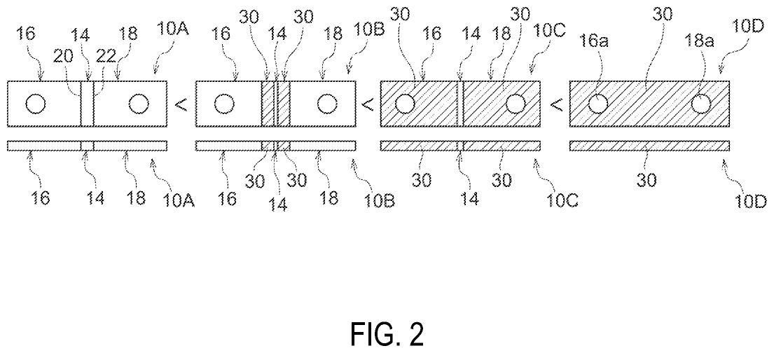

The shunt resistor 10 is provided with the plated portion 30 (see FIG. 2). The plated portion 30 covers at least each of joined portions 20 and 22 between the resistance body 14 and each of the electrodes 16 and 18 and is made of a plating having higher specific resistance than the resistance body 14. The plated portion 30 is formed so as to be in close contact with each of the joined portions 20 and 22. The plated portion 30 waterproofs and moisture-proofs each of the joined portions 20 and 22 and suppresses the occurrence of the galvanic corrosion at each of the joined portions 20 and 22 between the resistance body 14 and each of the electrodes 16 and 18, which are made of dissimilar metals.

FIG. 2 is an explanatory diagram used for explaining a relationship between a range and an effect of the plated portion 30 in the shunt resistor according to the first embodiment.

As shown in FIG. 2, in a shunt resistor 10A that does not have the plated portion 30, the galvanic corrosion may be caused if moisture comes into contact with each of the joined portions 20 and 22.

However, in a shunt resistor 10B in which each of the joined portions 20 and 22 between the resistance body 14 and each of the electrodes 16 and 18 is covered by the plated portion 30 on a top surface, a bottom surface, a left side surface, and a right side surface, it is possible to suppress the galvanic corrosion of each of the joined portions 20 and 22.

In addition, in a shunt resistor 10C in which each of the joined portions 20 and 22 and each of the electrodes 16 and 18 are entirely covered by the plated portion 30, following effects are achieved. In other words, in a case in which for example, a bus bar to be connected to each of the electrodes 16 and 18 is made of copper (Cu), which is a different metal from each of the electrodes 16 and 18, it is possible to further suppress the occurrence of the galvanic corrosion at a contact portion between each of the electrodes 16 and 18 and the bus bar. In addition, by employing the plated portion 30, it is possible to suppress diffusion of tin (Sn) contained in the brazing filler for brazing the bus bar to each of the electrodes 16 and 18.

Furthermore, in a shunt resistor 10D in which entire surfaces of the resistance body 14 and each of the electrodes 16 and 18 are covered by the plated portion 30, it is possible to suppress corrosion, discoloration, and so forth of the surface of the resistance body 14.

In the above, when the plating is applied to the shunt resistor 10 partially, additional processes, such masking, etc., and additional members are required, leading to an increase in cost. Thus, by applying the plating to the entire surface of the shunt resistor 10 and by covering the entire surface of the shunt resistor 10 with the plated portion 30, it is possible to reduce manufacturing cost.

### (Plated Portion)

The thickness the plated portion 30, which covers at least each of the joined portions 20 and 22, is set to be equal to or greater than 0.5 μm and equal to or smaller than 10.0 μm.

A ratio of the specific resistance of the plated portion 30 to the specific resistance of each of the electrodes 16 and 18 is greater than a ratio of the specific resistance of the resistance body 14 to the specific resistance of each of the electrodes 16 and 18. In addition, the resistance value of the plated portion 30 is at least 50 times the resistance value of the resistance body 14.

In the above, it is preferable that the resistance value of the plated portion 30 be at least 100 times the resistance value of the resistance body 14. Furthermore, it is further preferable that the resistance value of the plated portion 30 be at least 1000 times the resistance value of the resistance body 14.

In addition, the plated portion 30 is made of an alloy plating containing phosphorus (P) or boron (B). The alloy plating containing phosphorus (P) includes a Ni—P plating or a Ni—P—W plating. In addition, another alloy plating containing phosphorus (P) includes a Ni—P—Mo plating, a Ni—P—Cr plating, or a Ni—P—Re plating.

The alloy plating containing boron (B) includes a Ni—B plating, a Ni—B—W plating, a Ni—B—Mo plating, a Ni—B—Cr plating, a Ni—B—Re plating, or a Ni—B—P-based alloy plating.

It is preferable that the temperature coefficient of the resistance (TCR) of the plated portion 30 be equal to or lower than 200 ppm/° C., and the specific resistance be equal to or higher than 110 μΩ·cm.

The temperature coefficient of the resistance (TCR) can be obtained on the basis of the rate of change in the resistance value and the amount of change in temperature. For example, when the temperature of the material body that shows a first resistance value R1 at a first temperature T1 is changed to a second temperature T2 and the material body shows a second resistance value R2, the temperature coefficient of the resistance TCR [ppm/° C.] can be obtained by the following arithmetic expression.

TCR={(R2−R1)/R1}×1000000/{(T2−T1)}

Selection of the plating forming such a plated portion 30 will be described specifically.

A nickel (Ni)-based alloy plating is used for the plating forming the plated portion

30. The standard electrode potential of nickel (Ni) in the nickel (Ni)-based alloy plating forming the plated portion 30 is −0.26V, and the difference relative to the standard electrode potential of aluminum (Al) is smaller compared with a case for copper (Cu). Therefore, the galvanic corrosion hardly occurs in a contact portion between the plated portion 30 and each of the electrodes 16 and 18.

The standard electrode potential of aluminum (Al) forming each of the electrodes 16 and 18 is −1.70V. In addition, the standard electrode potential of copper (Cu), which is a common material for electrodes and the main component of the resistance body 14, is +0.349V.

In addition, the nickel (Ni)-based alloy plating can be made thinner compared with plastic. As a result, it is possible to cover the entire surface of the shunt resistor 10 without impairing its external shape.

In addition, the nickel (Ni)-based alloy plating has good adhesiveness to the metal material, and it adheres closely to each of the joined portions 20 and 22 between aluminum (Al) forming each of the electrodes 16 and 18 and copper (Cu) forming the resistance body 14.

Therefore, compared with a case in which moisture may enter from a contact interface between the plastic and the metal due to the structure in which each of the joined portions 20 and 22 is covered with plastic, it is possible to improve the moisture-proof and waterproof effects and to cover each of the joined portions 20 and 22 uniformly.

In addition, even when it is used at high temperature, compared with a case in which plastic is used, it is possible to prevent melting and burning.

The plated portion 30 has an electrically conductive property. Therefore, if the plated portion 30 is bridged between each of the electrodes 16 and 18 and the resistance body 14, a current flows also through the plated portion 30, and so, the electrical characteristics of the shunt resistor 10 are affected. Therefore, from the viewpoint of reducing the current flowing through the plated portion 30, it is preferable to use the plating material having high specific resistance for the alloy plating forming the plated portion 30.

In addition, in order to improve the temperature characteristics of the shunt resistor 10, it is preferable to use the plating material having low temperature coefficient of the resistance (TCR) for the alloy plating forming the plated portion 30.

Thus, in this embodiment, among nickel (Ni) alloy platings with high specific resistance and low temperature coefficient of the resistance (TCR), the Ni—P plating or the Ni—P—W plating is used as the plating material forming the plated portion 30.

The plating material forming the plated portion 30 with high specific resistance and low temperature coefficient of the resistance (TCR) is not limited to the Ni—P plating or the Ni—P—W plating. As the plating material forming the plated portion 30, as described above, a Ni—B-based alloy plating, the Ni—P—Mo plating, the Ni—P—Cr plating, or the Ni—P—Re plating may be used. In addition, when the joined portions 20 and 22 of the shunt resistor 10 are covered with a material other than plating, the joined portions 20 and 22 may also be covered by a Ni—Cr film, etc.

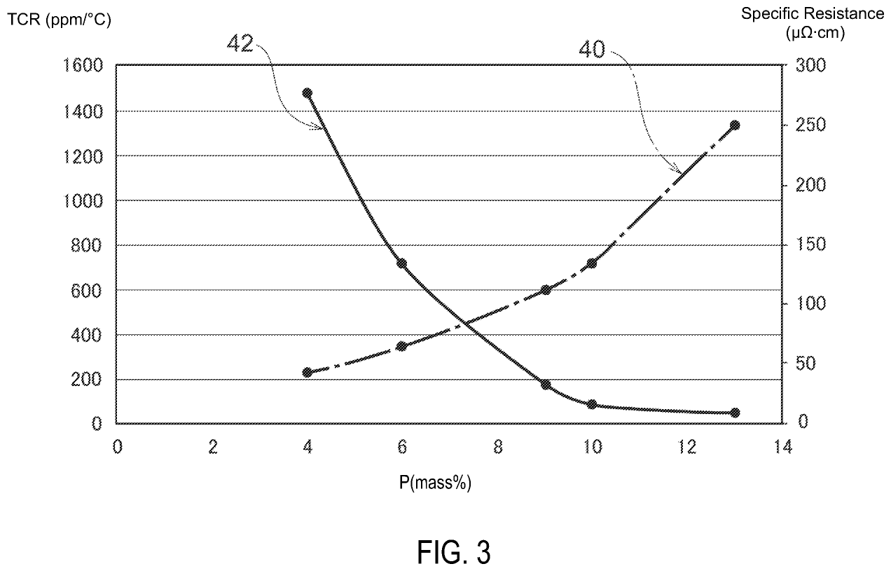

FIG. 3 is a graph showing a relationship between the added amount of phosphorus (P) and the specific resistance, and a relationship between the added amount of phosphorus (P) and the temperature coefficient of the resistance in the Ni-P plating material used in this embodiment.

(Ni—P plating)

The added amount of phosphorus (P) to the Ni—P plating used in an electroless plating process is varied, and FIG. 3 shows measurement results 40 of the specific resistance and measurement results 42 of the temperature coefficient of the resistance (TCR) for the plated portion 30, which is formed by the Ni—P plating with the respective added amounts.

From this figure, when the added amount of phosphorus (P) is equal to or higher than 9 mass % with respect to the total mass of the Ni—P plating, the specific resistance of the plated portion 30 becomes about 110 μΩ·cm, and the temperature coefficient of the resistance (TCR) becomes equal to or lower than 200 ppm/° C. In this case, the specific resistance of the plated portion 30 is higher than 108 μΩ·cm, which is the specific resistance of a Ni—Cr alloy (nichrome) that is commonly used as the resistance body 14.

In the above, the plating thickness of the plated portion 30 formed by the Ni—P plating is set to be equal to or greater than 2 μm and less than 10 μm. When the plating thickness is set to be equal to or greater than 2 μm, the resistance value of the plated portion 30 can be made to be at least 1000 times the resistance value of the resistance body 14. In addition, when the plating thickness is set to be less than 10 μm, the resistance value of the plated portion 30 can be made to be 200 times the resistance value of the resistance body 14. As a result, it is possible to reduce the influence of the plated portion 30 imparted to the resistance characteristics of the shunt resistor 10.

Therefore, it is preferable that the plated portion 30 be formed of the Ni—P plating, in which the added amount of phosphorus (P) is equal to or higher than 9 mass % with respect to the total mass of the Ni—P plating. By doing so, it is possible to set the specific resistance of the plated portion 30 to be equal to or higher than 110 μΩ·cm and to set the temperature coefficient of the resistance (TCR) to be equal to or lower than 200 ppm/° C.

In this case, it is possible to greatly reduce the influence imparted to the temperature coefficient of the resistance (TCR) of the whole shunt resistor 10 and to greatly suppress the influence imparted to the resistance characteristics of the shunt resistor 10.

Therefore, it is preferable that the plated portion 30 be formed of the Ni—P plating, in which the added amount of phosphorus (P) is equal to or higher than 9 mass % with respect to the total mass of the Ni—P plating.

When the added amount of phosphorus (P) was set to be equal to or higher than 9 mass % with respect to the total mass of the Ni—P plating in the Ni—P plating, the temperature coefficient of the resistance (TCR) of the plated portion 30 formed of this Ni—P plating was 200 ppm/° C. and the specific resistance thereof was 110 μΩ·cm.

The specific resistance of the Ni—Cr alloy (nichrome), which is used as a general resistance body, is 108 μΩ·cm, and the specific resistance of the plated portion 30 is equal to or greater than the specific resistance of the Ni—Cr alloy (nichrome). Therefore, the Ni—P plating, in which the added amount of phosphorus (P) is equal to or higher than 9 mass %, is suitable for the plating material forming the plated portion 30.

On the other hand, when the added amount of phosphorus (P) is 13 mass % with respect to the total mass of the Ni—P plating in the Ni—P plating forming the plated portion 30, the specific resistance is 250 μΩ·cm, and the temperature coefficient of the resistance (TCR) is 20 ppm/° C.

The plated portion 30 is applied to the shunt resistor that is provided with the resistance body 14 formed of a Cu—Mn—Ni alloy (Manganin®) having, for example, a minimum thickness of 0.5 mm and the specific resistance of 44 μΩ·cm. In this case, even if the plating thickness of the plated portion 30 is set to be 10 μm, it is possible to suppress the influence imparted to the temperature coefficient of the resistance (TCR) of the whole shunt resistor 10 to be equal to or lower than 0.1 ppm/° C.

As described above, by considering the relationship between the specific resistance of the resistance body 14 and the specific resistance of the plated portion 30 on the basis of the relationship between the thickness of the resistance body 14 and the plating thickness of the plated portion 30 of the shunt resistor 10, it is possible to design such that the influence of the plated portion 30 on the shunt resistor 10 is suppressed.

In addition, when the plated portion 30 is formed of a Ni—6P alloy plating, in which the added amount of phosphorus (P) is 6 mass % with respect to the total mass of the Ni—P plating, the specific resistance of the plated portion 30 is 70 μΩ·cm, and the temperature coefficient of the resistance (TCR) is 700 ppm/° C.

The specific resistance of the plated portion 30 formed of the Ni—6P alloy plating is at least 20 times higher than that of aluminum (Al) whose specific resistance is 2.7 μΩ·cm, and the specific resistance thereof is 1.5 times higher than that of the Cu—Mn—Ni alloy (Manganin®) whose specific resistance is 44 μΩ·cm.

As described above, the resistance value of the plated portion 30 formed of the alloy plating containing Ni as the main component can be made to be at least 1000 times the resistance value of the resistance body 14 of the shunt resistor 10, and therefore, it is possible to greatly suppress the influence imparted to the resistance characteristics of the shunt resistor 10.

In addition, by making the resistance value of the plated portion 30 to be at least 1000 times the resistance value of the resistance body 14 of the shunt resistor 10, it is possible to reduce the current flowing through the plated portion 30 to equal to or lower than 1/1000 of the current flowing through the shunt resistor 10. As a result, it is possible to suppress the electrical influence of the plated portion 30 to equal to or lower than 1/1000 of the whole shunt resistor 10, and so, it is possible to suppress the influence of the temperature coefficient of the resistance (TCR) to a single-digit ppm/° C. or lower.

Therefore, it is preferable that the resistance value of the plated portion 30 be set to be at least 1000 times the resistance value of the resistance body 14 of the shunt resistor 10.

Here, if the resistance value of the plated portion 30 is at least 50 times the resistance value of the resistance body 14, it is possible to suppress the influence of the plated portion 30 imparted to the resistance characteristics of the shunt resistor 10. In addition, it has been confirmed that if the resistance value of the plated portion 30 is at least 100 times the resistance value of the resistance body 14, it is possible to suppress the influence imparted to the resistance characteristics of the shunt resistor 10 to a double-digit ppm/° C.

Preferably, the temperature coefficient of the resistance (TCR) of the plated portion 30 is set to be equal to or lower than 200 ppm/° C.

Here, the resistance value of the plated portion 30 is set to be at least 1000 times the resistance value of the resistance body 14 of the shunt resistor 10, and the electrical influence of the plated portion 30 imparted to the shunt resistor 10 is equal to or lower than 1/1000 of the whole shunt resistor 10.

Therefore, it is possible to suppress the influence imparted to the temperature coefficient of the resistance (TCR) of the shunt resistor 10 to be equal to or lower than 0.2 ppm/° C.

When the added amount of phosphorus (P) becomes less than 4 mass % with respect to the total mass of the Ni—P plating, the specific resistance becomes equal to or lower than 44 μΩ·cm, which is the specific resistance of the Cu—Mn—Ni alloy (Manganin®) that is commonly used as the resistance body 14. Therefore, the Ni—P plating, in which the added amount of phosphorus (P) is less than 4 mass %, is not suitable as the plating material for the plated portion 30.

In addition, when the added amount of phosphorus (P) exceeds 13 mass % with respect to the total mass of the Ni—P plating, it becomes difficult to control the content of phosphorus (P) in the Ni—P plating. Therefore, the Ni-P plating, in which the added amount of phosphorus (P) exceeds 13 mass %, is not suitable as the plating material for the plated portion 30.

Here, the specific resistance of aluminum (Al) forming each of the electrodes 16 and 18 is 2.7 μΩ·cm. In addition, the specific resistance of the plated portion 30 can be set to be equal to or higher than 70 μΩ··cm even if the added amount of phosphorus (P) is 6 mass % with respect to the total mass of the Ni—P plating.

As described above, the ratio of the specific resistance of the plated portion 30 to the specific resistance of each of the electrodes 16 and 18 is greater than the ratio of the specific resistance of the resistance body 14 to the specific resistance of each of the electrodes 16 and 18.

In a case in which the plated portion 30 is formed of the Ni—P—W plating, the added amount of phosphorus (P) shall also be adjusted in the Ni—P—W plating, similarly to the case of the Ni—P plating. In addition, it is known that the temperature coefficient of the resistance (TCR) decreases with an increase in the added amount of tungsten (W) in the Ni—P—W plating. Ni—P—W Plating

The Ni—P—W plating will be described specifically.

The plated portion 30 was formed by using the Ni—P—W plating. In the Ni—P—W plating, the added amount of phosphorus (P) was 12 mass %, and the added amount of tungsten (W) was 2.5 mass % with respect to the total mass of the Ni—P—W plating. The temperature coefficient of the resistance (TCR) of the plated portion 30 formed of the Ni—P—W plating was 100 ppm/° C., and the specific resistance thereof was 155 μΩ·cm.

The specific resistance of the plated portion 30 is equal to or greater than the specific resistance of the Ni—Cr alloy (nichrome), which is used as the resistance body 14 in general. Therefore, the Ni—P—W plating, in which the added amount of phosphorus (P) is 12 mass % and the added amount of tungsten (W) is 2.5 mass %, is suitable as the plating material forming the plated portion 30.

### (Plating Thickness)

In the general shunt resistor 10, a minimum thickness of the shunt resistor 10 is about 0.5 mm. Therefore, the plating thickness of the plated portion 30 that is formed on the shunt resistor 10 is ideally 1/1000 of 0.5 mm, that is, 0.5 μm.

When the corrosion, etc. is to be suppressed in the plated portion 30, the presence of a hole in the plated portion 30 deteriorates a corrosion suppressing effect. It is known that the number of holes formed in the plated portion 30 is significantly reduced when the plating thickness is equal to or greater than 0.5 μm. Therefore, in order to ensure a protective performance by the plated portion 30, the plating thickness is preferably equal to or greater than 0.5 μm.

As described above, even if the plating thickness is made to be equal to or greater than 0.5 μm, as long as the specific resistance of the plated portion 30 is the same as the specific resistance of the resistance body 14, as described above, it is possible to ensure the resistance value 1000 times greater.

Therefore, even if the temperature coefficient of the resistance (TCR) of the plated portion 30 is about several thousand ppm/° C., it is possible to suppress the influence imparted to the temperature coefficient of the resistance (TCR) of the shunt resistor 10 to a single-digit ppm/°° C. or lower.

On the other hand, in a case in which the plated portion 30 having the plating thickness of 10 μm is formed on the resistance body 14 of the general shunt resistor 10 having a minimum thickness of 0.5 mm, thickness of the plated portion 30 relative to that of the resistance body 14 of the shunt resistor 10 is 1/50. In this case, when the specific resistances of the resistance body 14 and the plated portion 30 are set to be the same for example, the resistance value of the plated portion 30 becomes 50 times the resistance value of the resistance body 14.

Here, the specific resistance of the general plated portion 30 is lower than the specific resistance of the resistance body 14. For example, when the plated portion 30 is formed of a zinc (Zn) plating, the specific resistance of the plated portion 30 formed of the zinc (Zn) plating is 6 μΩ·cm. In addition, the specific resistance of the Cu—Mn—Ni alloy (Manganin®) forming the resistance body 14 is 44 μΩ·cm, and the specific resistance of the plated portion 30 is about 1/7 of the specific resistance of the resistance body 14.

In addition, the temperature coefficient of the resistance (TCR) of the zinc (Zn) plating is 3700 ppm/° C. In a case in which the plated portion 30 is formed of the zinc (Zn) plating, the influence of the plated portion 30 imparted to the temperature coefficient of the resistance (TCR) of the whole shunt resistor 10 is 528 ppm/° C. (3700×( 1/7)).

The plated portion 30 is formed on each of the top surface and the bottom surface of the resistance body 14. Therefore, the influence of the plated portions 30 imparted to the temperature coefficient of the resistance (TCR) of the shunt resistor 10 is about doubled.

As described above, when the plated portion 30 is formed of the plating having lower specific resistance than the resistance body 14, the influence imparted to the resistance characteristics of the shunt resistor 10 is significant even when the plating thickness is taken into account. For this reason, a general plating having lower specific resistance than the resistance body 14 is not suitable as the plating material for the plated portion 30.

Therefore, it is desirable that the specific resistance of the plated portion 30 be set to be equal to or higher than that of the resistance body 14, and the temperature coefficient of the resistance (TCR) of the plated portion 30 be set to be equal to or lower than 200 ppm/° C. In this case, it is possible to suppress the influence imparted to the temperature coefficient of the resistance (TCR) of the whole shunt resistor 10 to 4 ppm/° C. (200×( 1/50)).

As an example, in a case in which the resistance body 14 is formed of the Ni-Cr alloy (nichrome) having the specific resistance of 108 μΩ·cm, the specific resistance of the plated portion 30 is set to be 110 μΩ·cm, and the temperature coefficient of the resistance (TCR) is set to be 200 ppm/° C. In this case, even when the plating thickness of the plated portion 30 is set to be 10 μm, it is possible to suppress the influence imparted to the temperature coefficient of the resistance (TCR) of the whole shunt resistor 10 having a thickness of 0.5 mm to about 4 ppm/° C.

As a result, even in a case in which it is difficult to suppress the plating thickness of the plated portion 30 to about 5 μm and the plating thickness becomes thicker than 5 μm, it becomes possible to maintain the resistance characteristics.

### Functions and Effects

Next, functional advantages of the first embodiment will be described.

The shunt resistor 10 of this embodiment is provided with: the resistance body 14; and the electrode 16, 18 joined to the resistance body 14 and made of aluminum as the main component. In addition, the shunt resistor 10 is provided with the plated portion 30 configured to cover at least the joined portion 20, 22 between the resistance body 14 and the electrode 16, 18, the plated portion 30 being configured of the plating having higher specific resistance than the resistance body 14.

According to such a configuration, the joined portion 20, 22 between the resistance body 14 and the electrode 16, 18 containing aluminum as the main component is covered with the plated portion 30. With such a configuration, compared with a case in which the joined portion 20, 22 is exposed, it is possible to suppress the galvanic corrosion that may be caused when the resistance body 14 and the electrode 16, 18 are made of different metals.

In addition, the joined portion 20, 22 is covered with the plated portion 30 having higher specific resistance than the resistance body 14. As a result, compared with a case in which the joined portion 20, 22 is covered with a plating having lower specific resistance than the resistance body 14 and this plating is bridged between the electrode 16, 18 and the resistance body 14, it becomes possible to suppress the influence of the plated portion 30 imparted to the resistance characteristics of the shunt resistor 10.

In addition, the plated portion 30 have a higher specific resistance than the resistance body 14. As a result, compared with a case in which the plated portion 30 having a low specific resistance is used, it is possible to make the plating thickness thicker while suppressing the influence imparted to the resistance characteristics of the shunt resistor 10. As a result, a greater margin is allowed for the adjustment of the plating thickness.

In the above, when the plating is made of an alloy, there is a tendency for the specific resistance to increase and the temperature coefficient of the resistance (TCR) to decrease with the increase in an amount of solid solution of the additives.

Thus, in this embodiment, by forming the plated portion 30 using the plating having higher specific resistance than the resistance body 14, it is possible to make the temperature coefficient of the resistance (TCR) of the plated portion 30 lower than the temperature coefficient of the resistance (TCR) of the resistance body 14. As a result, it becomes possible to suppress the influence of the plated portion 30 imparted to the temperature characteristics of the shunt resistor 10.

In addition, in the shunt resistor 10 of this embodiment, the ratio of the specific resistance of the plated portion 30 to the specific resistance of the electrode 16, 18 is greater than the ratio of the specific resistance of the resistance body 14 to the specific resistance of the electrode 16, 18.

In other words, when the resistance value of the shunt resistor 10 is to be designed, it is desirable that the ratio of the specific resistance of the resistance body 14 be higher with respect to the specific resistance of the electrode 16, 18. In addition, it is desirable that the plated portion 30 covering the joined portion 20, 22 have the specific resistance that is higher than that of the resistance body 14 and that the ratio of the specific resistance of the plated portion 30 to the specific resistance of the electrode 16, 18 be greater than the ratio of the specific resistance of the resistance body 14 to the specific resistance of the electrode 16, 18.

Therefore, by employing such a configuration, it is possible to further increase the effect of suppressing the influence of the plated portion 30 imparted to the resistance characteristics of the shunt resistor 10.

In addition, in the shunt resistor 10 of this embodiment, the resistance value of the plated portion 30 is at least 50 times the resistance value of the resistance body 14.

According to such a configuration because the resistance value of the plated portion 30 is at least 50 times the resistance value of the resistance body 14, it is possible to further suppress the influence of the plated portion 30 imparted to the resistance characteristics of the shunt resistor 10.

In addition, in the shunt resistor 10 of this embodiment, the plated portion 30 is formed of the alloy plating containing phosphorus (P) or boron (B).

According to such a configuration, it is possible to form the plated portion 30 having a high specific resistance and low temperature coefficient of the resistance (TCR).

In addition, in the shunt resistor 10 of this embodiment, the resistance body 14 and the electrode 16, 18 are joined to each other without the conductive material such as the brazing filler, etc. disposed therebetween.

According to such a configuration, compared with a case in which the conductive material such as the brazing filler, etc. is disposed between the resistance body 14 and the electrode 16, 18, it is possible to improve the resistance characteristics of the shunt resistor 10. In addition, the plated portion 30 covering the joined portion 20, 22 is fixed more stably, and the surface of the plated portion 30 can be formed more uniformly.

In addition, in the shunt resistor 10 of this embodiment, the plated portion 30 is configured to cover the entire surface of the resistance body 14 and the electrode 16, 18.

According to such a configuration, it becomes possible to suppress the galvanic corrosion that may be caused when the bus bar, which is made of a metal different from aluminum, is connected to the electrode 16, 18 for example.

In addition, in the shunt resistor 10 of this embodiment, the plated portion 30 has the temperature coefficient of the resistance (TCR) of equal to or lower than 200 ppm/° C. and the specific resistance of equal to or higher than 110 μΩ·cm.

According to such a configuration, even when nichrome having relatively high specific resistance is used for the resistance body 14 for example, it is possible to suppress the temperature coefficient of the resistance (TCR) while ensuring the plating thickness.

In addition, in the shunt resistor 10 of this embodiment, the plated portion 30 is formed of the Ni—P plating or the Ni—P—W plating.

According to such a configuration, by forming the plated portion 30 using a Ni-based alloy plating, compared with a case in which copper is used, it is possible to suppress the difference in the standard electrode potential relative to aluminum forming the electrode 16, 18. As a result, it is possible to suppress the occurrence of the galvanic corrosion in the contact portion between the plated portion 30 and the electrode 16, 18.

In addition, compared with a case in which a covering film is formed by using plastic, with the plated portion 30 formed of the Ni-based alloy plating, a good adhesiveness is achieved for metals, and it can be formed to have a thin thickness. As a result, it is possible to cover the joined portion 20, 22 without impairing the shape of the shunt resistor 10.

Further, the Ni—P plating or the Ni—P—W plating forming the plated portion 30 has high specific resistance and low temperature coefficient of the resistance (TCR). Thus, it is possible to suppress the influence of the plated portion 30 imparted to the electrical characteristics of the shunt resistor 10.

In addition, in the shunt resistor 10 of this embodiment, the thickness of the plated portion 30 is equal to or greater than 0.5 μm and equal to or smaller than 10.0 μm.

According to such a configuration, by making the thickness of the plated portion 30 to be equal to or greater than 0.5 μm, it is possible to suppress the number of holes that may be formed in the plated portion 30. As a result, it is possible to improve the protective performance achieved by the plated portion 30.

In addition, by making the thickness of the plated portion 30 to be equal to or smaller than 10.0 μm, it is possible to suppress the temperature coefficient of the resistance (TCR).

In this embodiment, although a description has been given of an example in which the shunt resistor 10 has a rectangular plate shape, the shape of the shunt resistor 10 is not limited to this shape.

For example, the shunt resistor 10 may have a shape in which each of the electrodes is provided on the bottom surface of the resistance body 14, a shape in which the electrode having an L-shape is provided on the end surface of the resistance body 14, or a shape in which the electrode provided on the end surface of the resistance body 14 protrudes downward from the resistance body 14.

Although the embodiment of the present disclosure has been described in the above, the above-mentioned embodiment merely illustrates a part of application examples of the present disclosure, and the technical scope of the present disclosure is not intended to be limited to the specific configurations of the above-described embodiment.

1. A shunt resistor comprising:
a resistance body;
an electrode joined to the resistance body and made of aluminum as a main component; and
a plated portion configured to cover at least a joined portion between the resistance body and the electrode, the plated portion being configured of a plating having higher specific resistance than the resistance body.

2. The shunt resistor according to claim 1, wherein
a ratio of the specific resistance of the plated portion to the specific resistance of the electrode is greater than a ratio of the specific resistance of the resistance body to the specific resistance of the electrode.

3. The shunt resistor according to claim 1, wherein
a resistance value of the plated portion is at least 50 times a resistance value of the resistance body.

4. The shunt resistor according to claim 1, wherein
the plated portion is formed of an alloy plating containing phosphorus or boron.

5. The shunt resistor according to claim 1, wherein
the resistance body and the electrode are joined to each other without a conductive material disposed therebetween.

6. The shunt resistor according to claim 1, wherein
the plated portion is configured to cover an entire surface of the resistance body and the electrode.

7. The shunt resistor according to claim 1, wherein
the plated portion has a temperature coefficient of resistance of equal to or lower than 200 ppm/° C. and a specific resistance of equal to or higher than 110 μΩ·cm.

8. The shunt resistor according to claim 1, wherein
the plated portion is formed of a Ni—P plating or a Ni—P—W plating.

9. The shunt resistor according to claim 1, wherein
a thickness of the plated portion is equal to or greater than 0.5 μm and equal to or smaller than 10.0 μm.
